(19) United States
(12) Patent Application Publication
(10) Pub. No.: US 2013/0159680 A1
(43) Pub. Date: Jun. 20, 2013

(54) SYSTEMS, METHODS, AND COMPUTER PROGRAM PRODUCTS FOR PARALLELIZING LARGE NUMBER ARITHMETIC

(71) Applicants: Wei-yu Chen, San Jose, CA (US); Guei-yuan Lueh, San Jose, CA (US); Kaiyu Chen, Santa Clara, CA (US); Xiaozhu Kang, Fremont, CA (US)

(72) Inventors: Wei-yu Chen, San Jose, CA (US); Guei-yuan Lueh, San Jose, CA (US); Kaiyu Chen, Santa Clara, CA (US); Xiaozhu Kang, Fremont, CA (US)

(21) Appl. No.: 13/330,359

(22) Filed: Dec. 19, 2011

(51) Int. Cl. G06F 9/302; G06F 9/315

(52) U.S. Cl. 712/222; 712/E09.017; 712/E09.034

(57) ABSTRACT

Methods, systems, and computer program products for the performance of arithmetic operations on large numbers. The addition of large numbers may be parallelized by adding corresponding sections of the numbers in parallel. The multiplication of large numbers may be accomplished by applying a multiplier to a multiplicand after the latter is divided into sections, where the multiplication of the sections is performed in parallel. Products for each section are saved in high and low order vectors, which may then be aligned and added. The comparison of two large numbers may be performed by comparing the numbers, section by section, in parallel. In an embodiment, these processes may be performed in a graphics processing unit (GPU) having multiple cores. In an embodiment, such a GPU may be integrated into a larger die that also incorporates one or more conventional central processing unit (CPU) cores.

### BACKGROUND

Several technical fields have a need to process large numbers. Examples include cryptography, where numbers represented by hundreds or thousands of bits may need to be multiplied or raised to an exponent of similar length. Graphics processing also requires the manipulation of large numbers during the processing of pixels, polygons, and the geometry of scenes.

In response to these needs, libraries of software routines have been constructed in a variety of programming languages, e.g., C#. Python, and Java. These libraries, however, may be generally written for execution on conventional central processing units (CPUs), and may not be suitable for execution on a more specialized processor, such as a graphical processing unit (GPU).

### BRIEF DESCRIPTION OF THE DRAWINGS/FIGURES

FIG. 1 illustrates the organization of a large number into a number vector, according to an embodiment.

FIG. 2 illustrates the addition of large numbers, according to an embodiment.

FIG. 3 is a flow chart illustrating the addition of large numbers, according to an embodiment.

FIG. 4 illustrates the comparison of large numbers, according to an embodiment.

FIG. 5 is a flowchart illustrating the comparison of large numbers, according to an embodiment.

FIG. 6 illustrates the multiplication of large numbers, according to an embodiment.

FIG. 7 is a flowchart illustrating the multiplication of large numbers, according to an embodiment.

FIG. 8 is a diagram illustrating a multi-core processor on which parallel execution of arithmetic processes may take place, according to an embodiment.

FIG. 9 illustrates a computing system which may embody the processing described herein.

FIG. 10 illustrates a system in which the components and processes described herein may operate, according to an embodiment.

FIG. 11 illustrates a user device in which the components and processes described herein may operate, according to an embodiment.

In the drawings, the leftmost digit(s) of a reference number identifies the drawing in which the reference number first appears.

### DETAILED DESCRIPTION

An embodiment is now described with reference to the figures, where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the description. It will be apparent to a person skilled in the relevant art that this can also be employed in a variety of other systems and applications other than what is described herein.

Disclosed herein are methods, systems, and computer program products for the performance of arithmetic operations on large numbers. The addition of two large numbers may be parallelized by adding corresponding sections of the numbers in parallel. The multiplication of two large numbers may be accomplished by applying a multiplier to a multiplicand after the latter is divided into sections, where the multiplication of the sections may be performed in parallel. Products for each section may be saved in high and low order vectors, which may then be aligned and added. The comparison of two large numbers may be performed by comparing the numbers, section by section, in parallel. In an embodiment, these processes may be performed in a GPU having multiple cores. In an embodiment, such a GPU may be integrated into a larger die that also incorporates one or more conventional CPU cores.

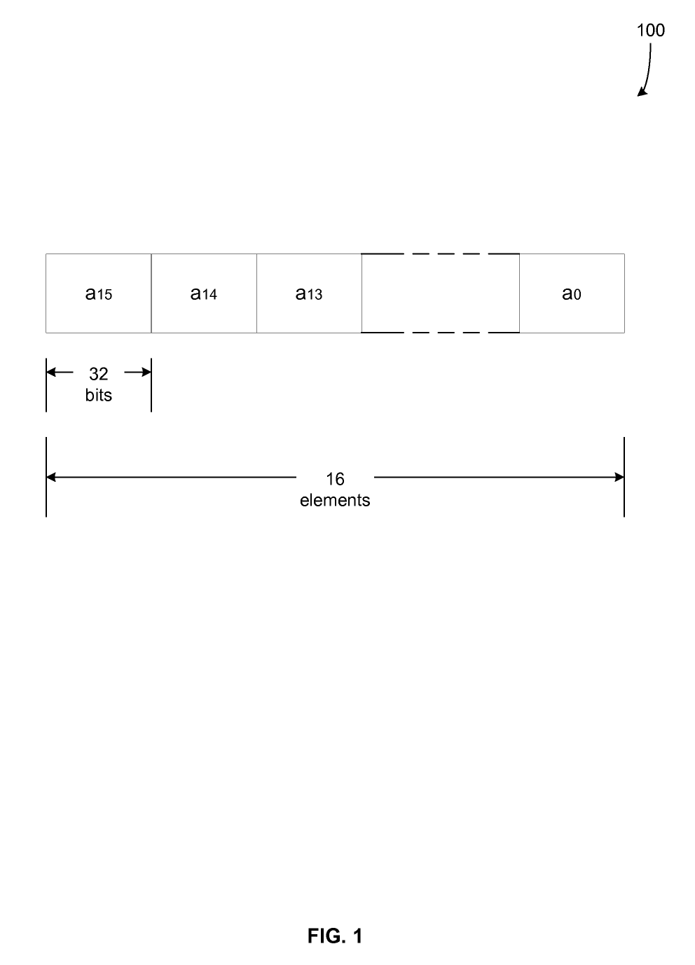

In embodiments, the binary representations of the numbers to be processed may first be divided into sections, to allow parallel processing of each section simultaneously. This organization of the binary representations of numbers is illustrated in FIG. 1. In this example, the binary representation of a 512 bit number may be organized as a number vector 100. This number vector may consist of 16 elements, shown here as a₁₅ . . . a₀. In the illustrated embodiment, each element may be 32 bits long. In alternative embodiments, there may be a different number of elements in the number vector, and a given element may have some number of bits other than 32.

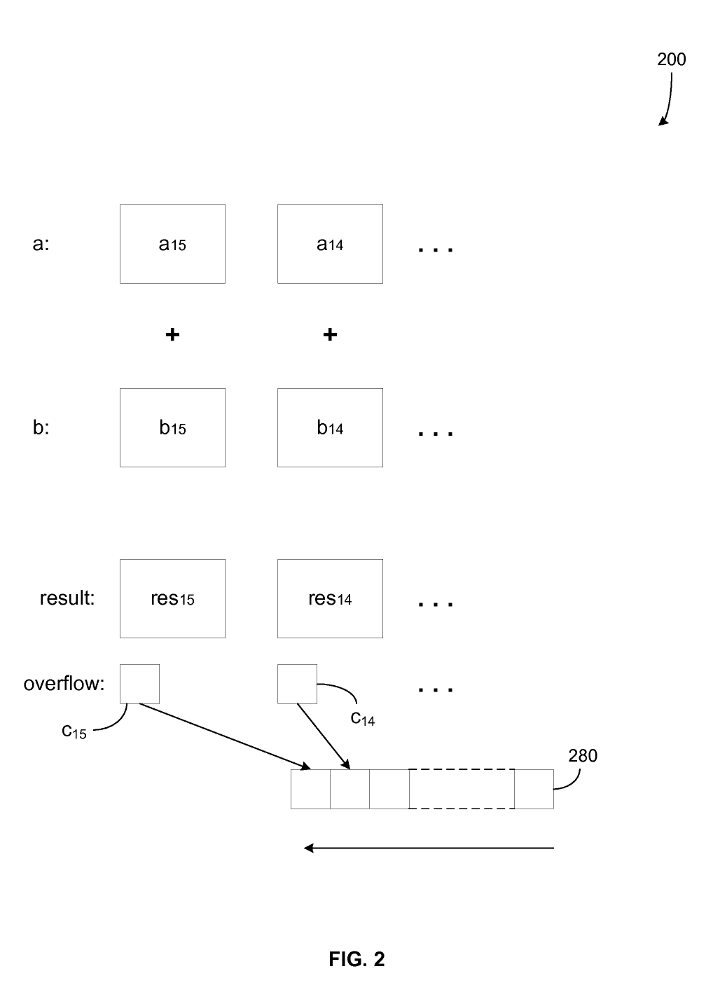

FIG. 2 illustrates an addition process, according to an embodiment. The two numbers to be added are shown here as a and b. In this illustration, each is represented as 512 bits. Each may be organized as a 16-element vector, a₁₅ . . . a₀ and b₁₅ . . . b₀. In the illustrated embodiment, each element of each vector consists of 32 bits. To perform the addition, a and b may be added element by element, so that aᵢ may be added to bᵢ, for i=0, . . . 15. These additions may be performed essentially simultaneously, in parallel. In an embodiment, each addition may be executed by its own GPU core. The sums may be stored in respective elements of a result vector shown here as res, so that resᵢ=aᵢ+bᵢ.

Each addition may result in an overflow bit. These are shown as “carry” bits c₁₅, c₁₄, etc. In an embodiment, these bits may be formatted, or “packed”, into a single integer variable 280, where each bit cᵢ of integer 280 corresponds to one of the result elements. The bits of integer 280 may then be left-shifted by one place. If a 1 is shifted out initially, it may be saved to be used as the most significant bit of the eventual sum of a and b. The shifted bits of integer 280 may then be loaded into b₁₅ . . . b₀ respectively, and the elements of the results vector loaded into a₁₅ . . . a₀. The contents of a and b may then be added again, in parallel as before, and the overflow bits packed into integer 280. The process may halt when there are no overflow bits, i.e., when integer 280 is all zeroes. Otherwise, the bits of integer 280 may be left-shifted again and the process repeated.

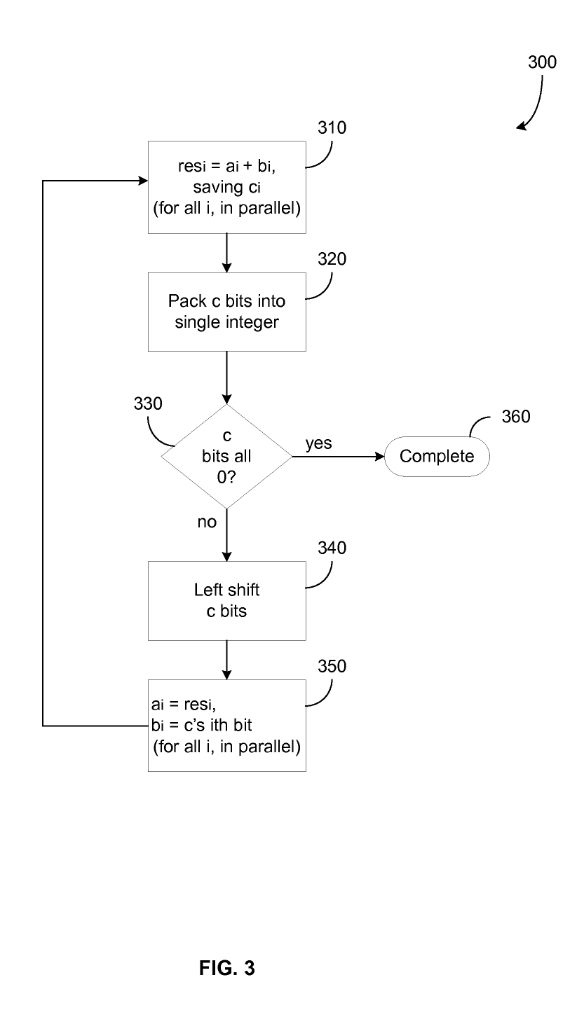

This process is illustrated in FIG. 3. At 310, each a, may be added to its respective bᵢ, the sum may be stored in resᵢ, and any respective overflow bit may be saved in cᵢ. The additions may all be performed in parallel. As stated above, each addition of aᵢ+bᵢ may be performed in its own core of a multi-core processor. At 320, the overflow bits cᵢ may be packed into an integer variable of a length equal to the number of elements in the number vectors a and b. At 330, a determination may be made as to whether all the bits cᵢ are 0. If not, the process may continue at 340. Here, the bits of the integer variable may be left-shifted by one. At 350, resᵢ may be stored in and cᵢ may be stored in bᵢ, for all i between 0 and 15. The value assignments of 350 may be performed in parallel, across all i. The process may then return to 310. If, at 330, all bits cᵢ are zero, then the addition of the original numbers may be complete at 360.

The logic of FIG. 3 may be implemented in a programming language that takes advantage of multiple cores in a processor, in which a process may be executed in parallel. One example of such a language is the C for Media language (CM). Another language may be used in an alternative embodiment. One example of a CM routine that implements the logic of FIG. 3 is as follows:

uint add_512_simd( vector<uint, 16> a, vector<uint, 16>b,
vector_ref<uint, 16> res ) {

ushort c_bits; //carry bits
uint temp=a(15);
do {

res = a + b
c_bits = cm_pack_mask( res < a );
a = res;
b = cm_unpack_mask<ushort, 16>( c_bits << 1 );

} while (c_bits != 0);
return temp > a(15);

}

The detection of overflow for any of the individual additions may be performed using a comparison operation. The final carry bit may be detected by “temp>a(15)” and in this way is not lost.

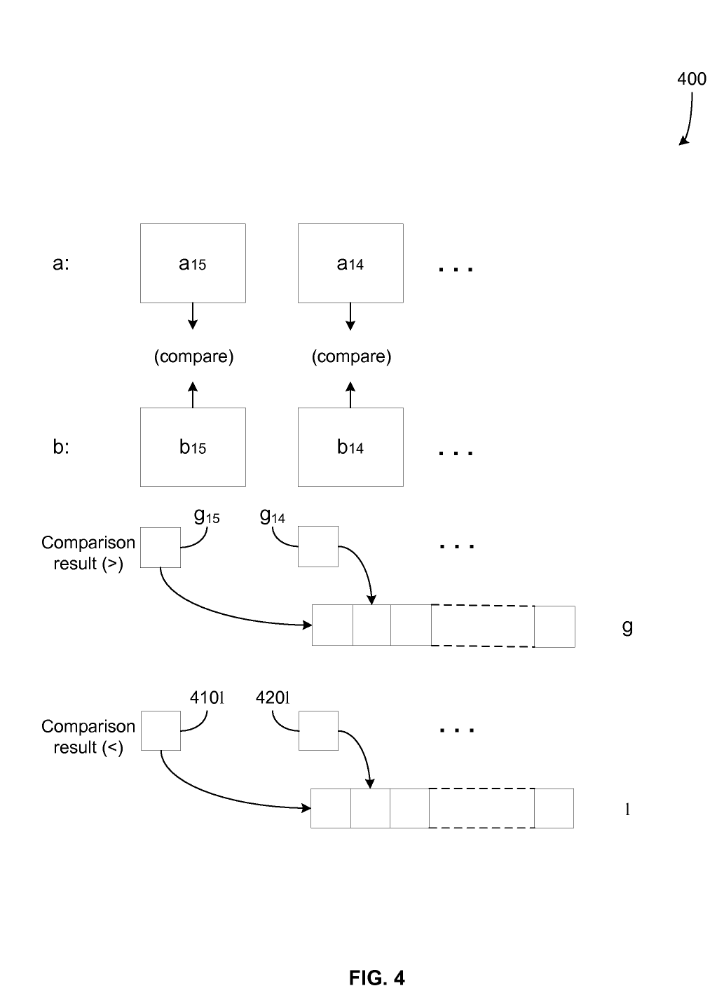

A parallel processing approach may also be applied to the comparison of large numbers. This is illustrated in FIG. 4. As before, two large numbers are shown as a and b. In an embodiment, these numbers may be 512 bits long. The numbers may be decomposed into smaller sections. For example, these segments may be 32 bits long. As a result, a 512 bit number may be divided into 16 sections of 32 bits each. Moreover, each large number may then be represented as a vector of 16 elements, one 32-bit section per element. In alternative embodiments, the numbers may be longer or shorter than 512 bits, the sections may be longer or shorter than 32 bits, and the number vectors may be longer or shorter than 16 elements.

As shown, each element of a may be compared with a corresponding element of b. The comparison of these elements may be performed in parallel across all elements. In an embodiment, each comparison may be performed in its own core of a multi-core GPU. The results of the comparisons may be saved as follows. Two vectors may be maintained, shown as vectors g and l. The lengths of these vectors correspond to the lengths of the a and b number vectors, e.g., 16 elements in an embodiment. If aᵢ>bᵢ, then the corresponding element in the g vector, gᵢ, may be set to 1. Otherwise, gᵢ may be 0. If aᵢ<bᵢ, then the corresponding element in the l vector, lᵢ, may be set to 1. Otherwise, lᵢ, may be 0.

In the illustrated embodiment, the elements of g may be packed into a single integer; likewise, the elements of l may be packed into a single integer. The resulting integers g and l may then be compared. If g<l, then a<b. If g>l, then a>b. If g=l, then both integers g and l are equal to 0, and a=b.

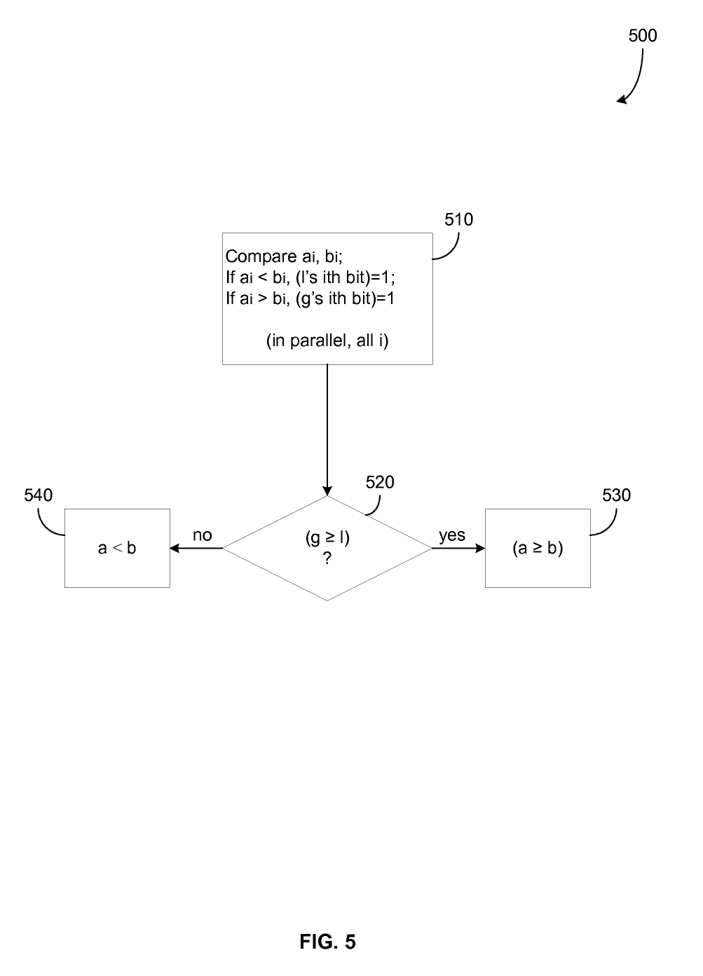

This process is illustrated in the flowchart of FIG. 5, according to an embodiment. At 510, each element aᵢ of the number vector a may be compared to its corresponding element bᵢ of the number vector b. As described above, the comparisons of these elements may be performed in parallel over all values of i from 0 to 15. If aᵢ>bᵢ, then the corresponding bit in the integer g may be set to 1. Otherwise, this bit may be 0. If aᵢ<bᵢ, then the corresponding bit in the integer l may be set to 1. Otherwise, this bit may be 0.

At 520, g may be compared to l. If g is greater than or equal to l, then it may be determined at 530 that a is greater than or equal to b. If it is determined that 520 that g is not greater than or equal to l, then at 540 it may be determined that a is less than b.

The logic of FIG. 5 may be implemented in a programming language such as CM. An example of a CM routine that implements the logic of FIG. 5 is as follows:

bool cmp_ge_512_simd( vector<uint, 16> a, vector<uint, 16> b ) {

ushort g = cm_pack_mask( a.select<16,l>(0) > b);
ushort l = cm_pack_mask( a.select<16,l>(0) < b);
return g >=l;

}

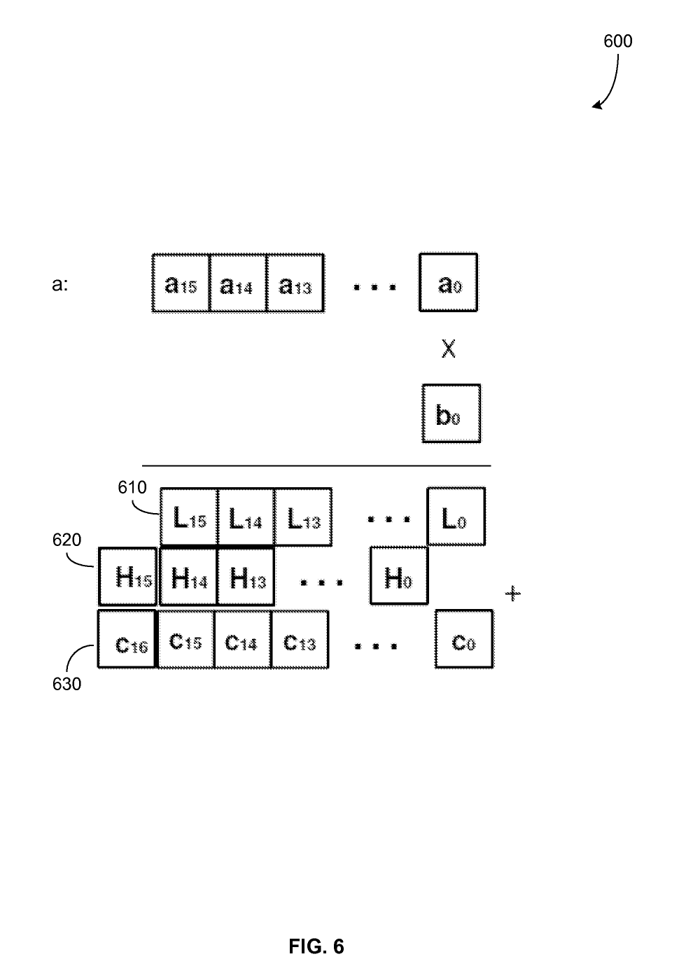

Parallel processing may also be applied in the multiplication of large numbers. This is illustrated in FIG. 6, according to an embodiment. As before, two large numbers are shown as a and b. In an embodiment, these numbers may be 512 bits long. The numbers may be decomposed into smaller sections. For example, these segments may be 32 bits long each. As a result, a 512 bit number may be divided into 16 sections of 32 bits each. Moreover, each large number may then be represented as a vector of 16 elements, one 32-bit section per element. In alternative embodiments, the numbers may be longer or shorter than 512 bits, the sections may be longer or shorter than 32 bits, and the number vector may be longer or shorter than 16 elements.

In the in the illustrated embodiment, a may be multiplied by a single element of the number vector b. The process may be repeated with each of the elements of b, and the products added to yield the aggregate product of a and b. In the illustration, each of the 16 elements of the number vector a may be multiplied by b₀. These 16 multiplications may be performed in parallel in an embodiment. Moreover, each of these multiplications may be executed by an individual core in a multi-core GPU.

Each multiplication of aᵢ×b₀ may result in a value that is 64 bits in length, given that each of b₀ and aᵢ is 32 bits in length. The 64-bit product may be organized into a 32-bit high order component and a 32-bit low order component. The high order component of the product of aᵢ×b₀ is shown as H₀; the low order component is shown as L₀. After each of the elements aᵢ has been multiplied by b₀, all of the high order components of the products may be organized as a single number vector H, having elements H₁₅ . . . H₀ and shown as number vector 620. Similarly, all of the low order elements of the products may be organized as a single number vector L, having elements L₁₅ . . . L₀ and shown as number vector 610. The product a×bₒ may then be obtained by adding L and H. However, these two number vectors need to first be aligned properly, so that Hₖ may be aligned with Lₖ₊₁, for all k between 14 and 0, as shown in FIG. 6. Once this alignment is completed, the addition of the number vectors L and H may proceed. In an embodiment, this addition process may take place as described above with respect to FIGS. 2 and 3. As described above with respect to the addition process, a vector 630 of overflow bits may be required.

The result may be the product a×b₀. The process above may then be repeated with b₁, then with b₂, etc. resulting in 16 products a×bⱼ for j between 0 and 15. The products may then be combined to yield the sum a×b.

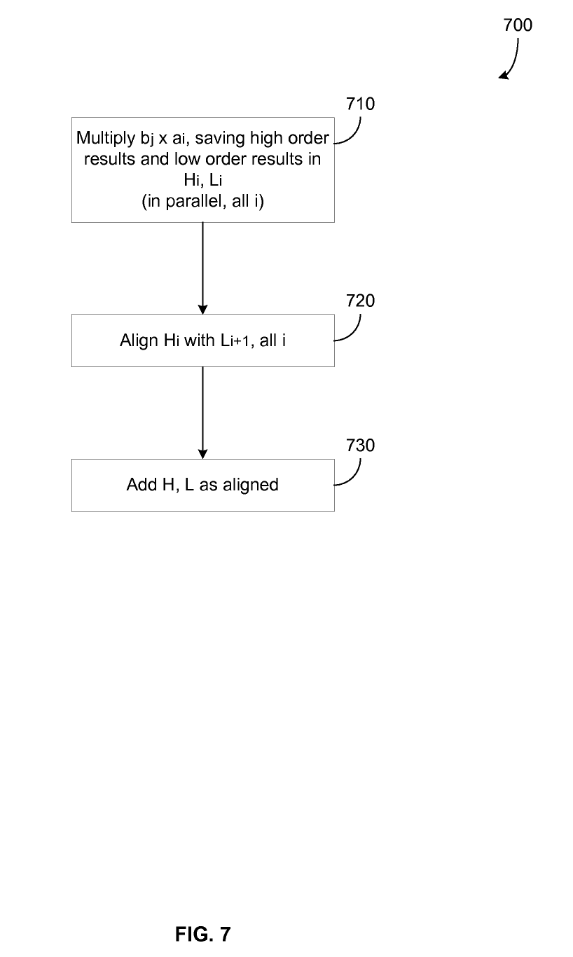

The multiplication process is illustrated by the flowchart of FIG. 7. At 710, aᵢ and bⱼ may be multiplied, where high order results and low order results may be saved in Hi and Li respectively. This may be performed in parallel over all values of i. As noted above, an embodiment, i may range between 0 and 15. At 720, the number vectors H and L may be aligned such that Hₖ may be aligned with Lₖ₊₁, for all k between 14 and 0, as shown in FIG. 6. At 730, H and L may be added after having been aligned in this manner. The addition of H and L may proceed as described above with respect to FIGS. 2 and 3, in a parallel manner.

The logic of FIG. 7 may be implemented in a programming language such as CM. An example of a CM routine that implements the logic of FIG. 7 is as follows:

//performs z = x*y, x is 512-bit integer, y is 32-bit integer
uint mul_512_simd(vector<uint, 16> x, uint y, vector_ref<uint, 16>
res) {

vector<uint, 16> prod, lo, hi;
uint leading; //the leading 32-bits
uint cy;
hi = cm_imul(lo, x, y);
leading = hi(15);
prod(0) = 0
prod.select<15, 1>(l) = hi.select<15,l>(0);
cy = add_512_simd( prod, lo, res);
return leading + cy;

}

Where the logic of FIGS. 3, 5, and 7 is implemented using the CM language, an application using CM may consist of two modules: the host application/program to be executed on conventional CPU cores, e.g., x86 CPU cores, and device functions (also termed as ‘kernels’) targeted for GPU cores. The host application may be a normal C/C++ program that can be compiled by any C++ compiler to x86 binary for CPU execution. However, in order to utilize the GPU to accelerate certain segments of the code, developers may setup and invoke the device or GPU through CM-runtime API calls inserted into the host program. The GPU-targeted code in turn may be organized into kernels that may be written in the CM language and processed by the CM compiler to create machine code that executes on the GPU cores. The GPU kernels may be instantiated into user-specified number of threads. Each thread may then be scheduled to run on an in-order SIMD processing unit called the Execution Unit (EU). Unlike OpenCL or CUDA, a single thread in CM may operate on a block of data. SIMD computations over this block of data may be expressed in CM and efficiently translated to a GPU-EU ISA (Instruction Set Architecture) by the CM compiler.

First, the GPU kernels may be compiled by the CM compiler to an intermediate language (called Common-ISA) file. Common-ISA may be a high-level, generic assembly language that can be translated to run on any current or future GPU. At runtime, a CM just-in-time (JIT) compiler translates the Common-ISA into executable code. Next, the application may be compiled into x86 binary with a C++ compiler of the developer's choice. At runtime, the application may calls the CM-runtime APIs to setup and execute on the GPUs. The CM runtime may provide the desired hardware abstraction layer to the application. It may manage device-creation, setting-up input and output buffers, kernel-creation, setting-up thread arguments, and dispatching kernels to the GPU. During kernel-creation, CM runtime may invoke the JIT compiler to generate GPU binary from Common-ISA. Subsequently, thread creation and scheduling may be performed entirely in hardware by the GPU's thread dispatcher.

One or more features disclosed herein may therefore be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein. The computer readable medium may be transitory or non-transitory. An example of a transitory computer readable medium may be a digital signal transmitted over a radio frequency or over an electrical conductor, through a local or wide area network, or through a network such as the Internet. An example of a non-transitory computer readable medium may be a compact disk, a flash memory, random access memory, read-only memory, or other data storage device.

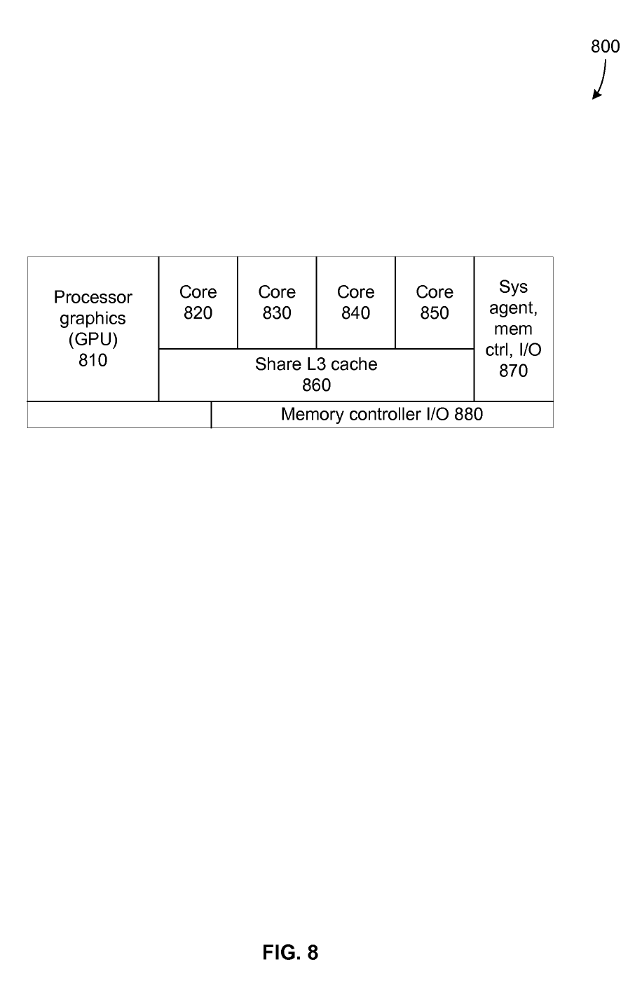

As noted above, the processes of addition, multiplication, and comparison of large numbers may be implemented through parallel processing. In an embodiment, the individual threads may be executed in parallel, where each thread executes on its own core in a multi-core processor. Such a plurality of cores may reside in a GPU. Moreover, such a GPU may reside on the same die as a conventional CPU or a multi-core CPU. An example of such a die is illustrated in block diagram form in FIG. 8. The die 800 includes processor graphics 810. This section may include a plurality of cores used to perform graphics processing. Such processing may include large number arithmetic as described above. The addition, multiplication, and comparison of large numbers may be executed in a parallel manner, taking advantage of the plurality of cores in processor graphics 810. Die 800 may also include a plurality of conventional CPU cores 820 through 850. Die 800 may also include a level 3 (L3) memory cache 860, memory controller I/O circuitry 880, and additional circuitry contained in section 870. In the illustrated embodiment, the latter section of the die 800 may include a system agent, a memory controller, and I/O circuitry.

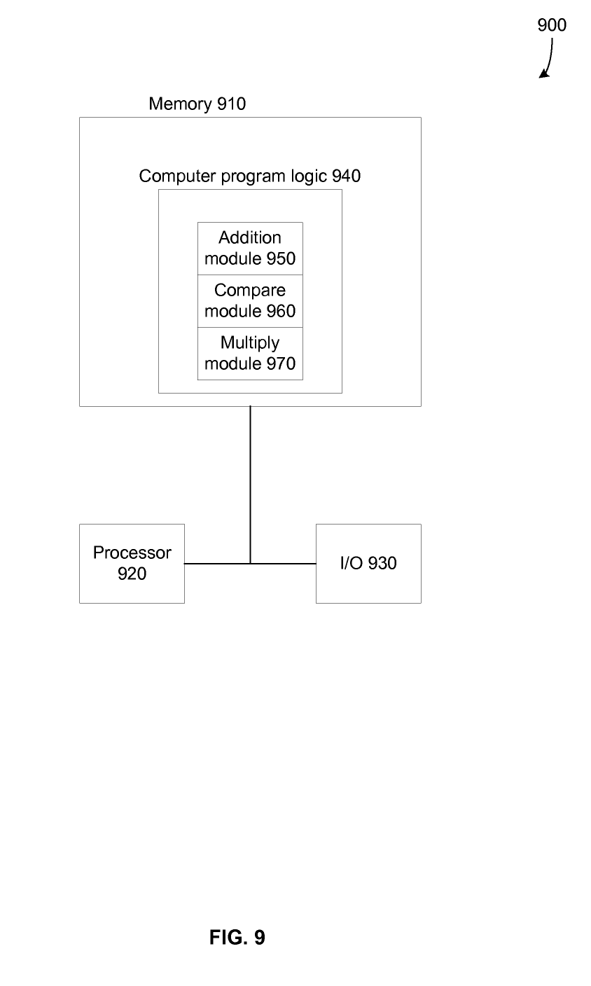

Software or firmware implementing the logic described above may therefore execute on a processor embodied on a die such as the one shown in FIG. 8. A system that incorporates such a processor and such software/firmware is shown in FIG. 9. The illustrated system 900 may include one or more processor(s) 920 and may further include a body of memory 910. Processor(s) 920 may include one or more central processing unit cores and/or a graphics processing unit having one or more GPU cores. Memory 910 may include one or more computer readable media that may store computer program logic 940. Memory 910 may be implemented as a hard disk and drive, a removable media such as a compact disk, a read-only memory (ROM) or random access memory (RAM) device, for example, or some combination thereof. Processor(s) 920 and memory 910 may be in communication using any of several technologies known to one of ordinary skill in the art, such as a bus. Computer program logic 940 contained in memory 910 may be read and executed by processor(s) 920. One or more I/O ports and/or I/O devices, shown collectively as I/O 930, may also be connected to processor(s) 920 and memory 910. In an embodiment, processor 920 may be implemented as device 800 of FIG. 8.

Computer program logic 940 may include logic that embodies the processing described above. In the illustrated embodiment, computer program logic 940 may include an addition module 950 that embodies the logic described above with respect to FIGS. 2 and 3. Computer program logic 940 may also include a compare module 960 that embodies the logic described above with respect to FIGS. 4 and 5. Computer program logic 940 may also include a multiply module 970 that embodies the logic described above with respect to FIGS. 6 and 7.

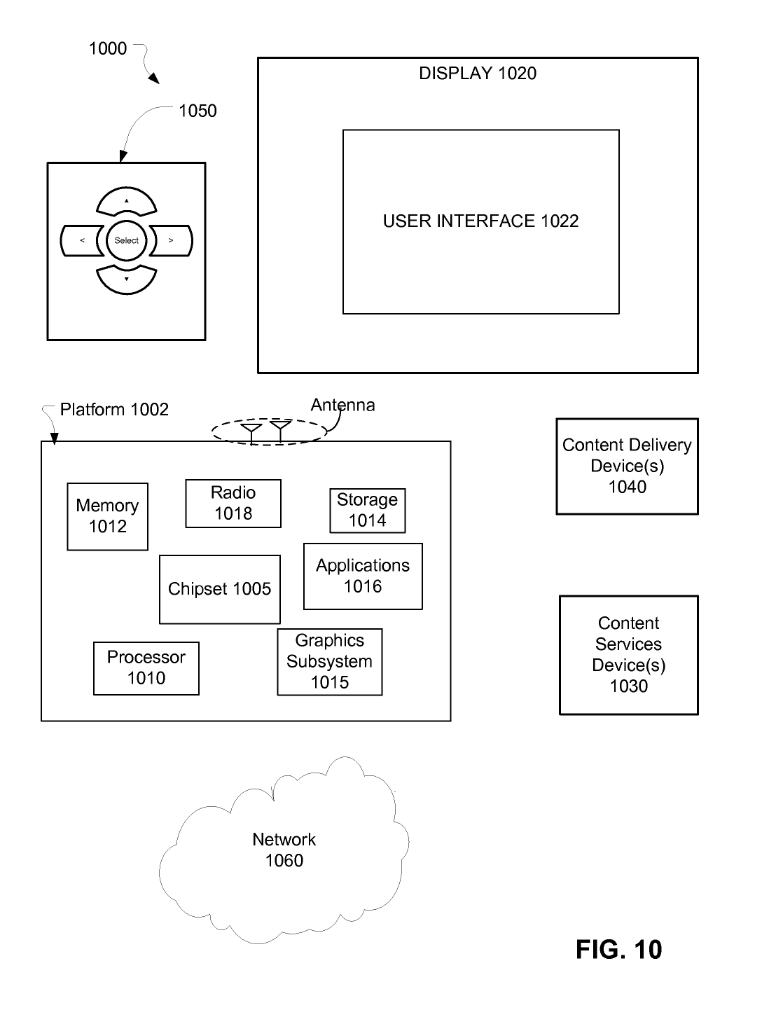

FIG. 10 illustrates a system 1000 which may embody the components and processing described above. In embodiments, system 1000 may be a media system although system 1000 is not limited to this context. For example, system 1000 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In embodiments, system 1000 comprises a platform 1002 coupled to a display 1020. Platform 1002 may receive content from a content device such as content services device(s) 1030 or content delivery device(s) 1040 or other similar content sources. A navigation controller 1050 comprising one or more navigation features may be used to interact with, for example, platform 1002 and/or display 1020. Each of these components is described in more detail below.

In embodiments, platform 1002 may comprise any combination of a chipset 1005, processor 1010, memory 1012, storage 1014, graphics subsystem 1015, applications 1016 and/or radio 1018. Chipset 1005 may provide intercommunication among processor 1010, memory 1012, storage 1014, graphics subsystem 1015, applications 1016 and/or radio 1018. For example, chipset 1005 may include a storage adapter (not depicted) capable of providing intercommunication with storage 1014.

Processor 1010 may be implemented as Complex Instruction Set Computer (CISC) or Reduced Instruction Set Computer (RISC) processors, x86 instruction set compatible processors, multi-core, or any other microprocessor or central processing unit (CPU). In embodiments, processor 1010 may comprise dual-core processor(s), dual-core mobile processor(s), and so forth.

Memory 1012 may be implemented as a volatile memory device such as, but not limited to, a Random Access Memory (RAM), Dynamic Random Access Memory (DRAM), or Static RAM (SRAM).

Storage 1014 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In embodiments, storage 1014 may comprise technology to increase the storage performance enhanced protection for valuable digital media when multiple hard drives are included, for example.

Graphics subsystem 1015 may perform processing of images such as still or video for display. Graphics subsystem 1015 may include a GPU or a visual processing unit (VPU), for example. An analog or digital interface may be used to communicatively couple graphics subsystem 1015 and display 1020. For example, the interface may be any of a High-Definition Multimedia Interface, DisplayPort, wireless HDMI, and/or wireless HD compliant techniques. Graphics subsystem 1015 could be integrated into processor 1010 or chipset 1005. Graphics subsystem 1015 could be a stand-alone card communicatively coupled to chipset 1005. In an embodiment, the transcoding and other video processing applications described above may be implemented in graphics subsystem 1015. In an embodiment, subsystem 1015 may include a component such as die 800.

The graphics and/or video processing techniques described herein may be implemented in various hardware architectures. For example, graphics and/or video functionality may be integrated within a chipset. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

Radio 1018 may include one or more radios capable of transmitting and receiving signals using various suitable wireless communications techniques. Such techniques may involve communications across one or more wireless networks. Exemplary wireless networks include (but are not limited to) wireless local area networks (WLANs), wireless personal area networks (WPANs), wireless metropolitan area network (WMANs), cellular networks, and satellite networks. In communicating across such networks, radio 1018 may operate in accordance with one or more applicable standards in any version.

In embodiments, display 1020 may comprise any television type monitor or display. Display 1020 may comprise, for example, a computer display screen, touch screen display, video monitor, television-like device, and/or a television. Display 1020 may be digital and/or analog. In embodiments, display 1020 may be a holographic display. Also, display 1020 may be a transparent surface that may receive a visual projection. Such projections may convey various forms of information, images, and/or objects. For example, such projections may be a visual overlay for a mobile augmented reality (MAR) application. Under the control of one or more software applications 1016, platform 1002 may display user interface 1022 on display 1020.

In embodiments, content services device(s) 1030 may be hosted by any national, international and/or independent service and thus accessible to platform 1002 via the Internet, for example. Content services device(s) 1030 may be coupled to platform 1002 and/or to display 1020. Platform 1002 and/or content services device(s) 1030 may be coupled to a network 1060 to communicate (e.g., send and/or receive) media information to and from network 1060. Content delivery device(s) 1040 also may be coupled to platform 1002 and/or to display 1020.

In embodiments, content services device(s) 1030 may comprise a cable television box, personal computer, network, telephone, Internet enabled devices or appliance capable of delivering digital information and/or content, and any other similar device capable of unidirectionally or bidirectionally communicating content between content providers and platform 1002 and/display 1020, via network 1060 or directly. It will be appreciated that the content may be communicated unidirectionally and/or bidirectionally to and from any one of the components in system 1000 and a content provider via network 1060. Examples of content may include any media information including, for example, video, music, medical and gaming information, and so forth.

Content services device(s) 1030 receives content such as cable television programming including media information, digital information, and/or other content. Examples of content providers may include any cable or satellite television or radio or Internet content providers. The provided examples are not meant to limit embodiments of the invention.

In embodiments, platform 1002 may receive control signals from navigation controller 1050 having one or more navigation features. The navigation features of controller 1050 may be used to interact with user interface 1022, for example. In embodiments, navigation controller 1050 may be a pointing device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures.

Movements of the navigation features of controller 1050 may be echoed on a display (e.g., display 1020) by movements of a pointer, cursor, focus ring, or other visual indicators displayed on the display. For example, under the control of software applications 1016, the navigation features located on navigation controller 1050 may be mapped to virtual navigation features displayed on user interface 1022, for example. In embodiments, controller 1050 may not be a separate component but integrated into platform 1002 and/or display 1020. Embodiments, however, are not limited to the elements or in the context shown or described herein.

In embodiments, drivers (not shown) may comprise technology to enable users to instantly turn on and off platform 1002 like a television with the touch of a button after initial boot-up, when enabled, for example. Program logic may allow platform 1002 to stream content to media adaptors or other content services device(s) 1030 or content delivery device(s) 1040 when the platform is turned “off” In addition, chip set 1005 may comprise hardware and/or software support for surround sound audio and/or high definition surround sound audio, for example. Drivers may include a graphics driver for integrated graphics platforms. In embodiments, the graphics driver may comprise a peripheral component interconnect (PCI) Express graphics card.

In various embodiments, any one or more of the components shown in system 1000 may be integrated. For example, platform 1002 and content services device(s) 1030 may be integrated, or platform 1002 and content delivery device(s) 1040 may be integrated, or platform 1002, content services device(s) 1030, and content delivery device(s) 1040 may be integrated, for example. In various embodiments, platform 1002 and display 1020 may be an integrated unit. Display 1020 and content service device(s) 1030 may be integrated, or display 1020 and content delivery device(s) 1040 may be integrated, for example. These examples are not meant to limit the invention.

In various embodiments, system 1000 may be implemented as a wireless system, a wired system, or a combination of both. When implemented as a wireless system, system 1000 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1000 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 1002 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 10.

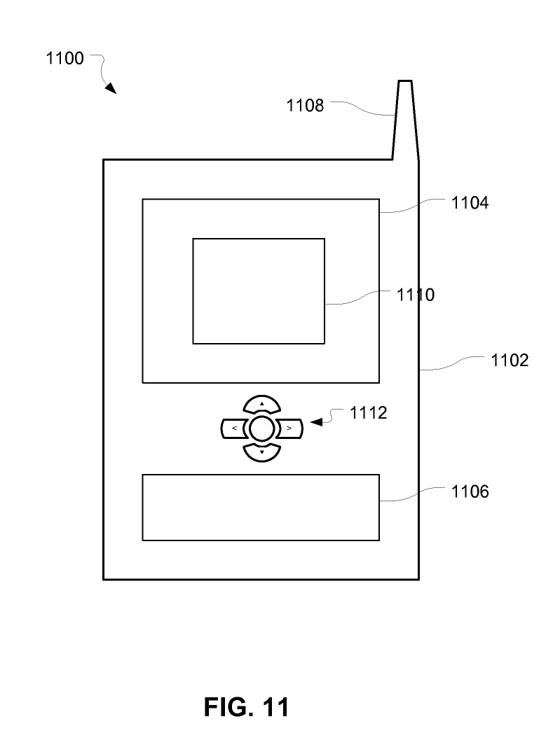

As described above, system 1000 may be embodied in varying physical styles or form factors. FIG. 11 illustrates embodiments of a small form factor device 1100 in which system 1000 may be embodied. In embodiments, for example, device 1100 may be implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

Examples of a mobile computing device also may include computers that may be arranged to be worn by a person, such as a wrist computer, finger computer, ring computer, eyeglass computer, belt-clip computer, arm-band computer, shoe computers, clothing computers, and other wearable computers. In embodiments, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 11, device 1100 may comprise a housing 1102, a display 1104, an input/output (I/O) device 1106, and an antenna 1108. Device 1100 also may comprise navigation features 1112. Display 1104 may comprise any suitable display unit for displaying information appropriate for a mobile computing device. I/O device 1106 may comprise any suitable I/O device for entering information into a mobile computing device. Examples for I/O device 1106 may include an alphanumeric keyboard, a numeric keypad, a touch pad, input keys, buttons, switches, rocker switches, microphones, speakers, voice recognition device and software, and so forth. Information also may be entered into device 1100 by way of microphone. Such information may be digitized by a voice recognition device. The embodiments are not limited in this context.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
organizing a binary representation of a first number as a first number vector having a number of elements;
organizing a binary representation of a second number as a second number vector having the same number of elements as the first number vector;
adding each element of the first number vector with a corresponding element of the second number vector, where the additions are performed in parallel, and storing each sum into a respective element of a results vector having the same number of elements as the first number vector;
packing resulting overflow bits, whether 0 or 1, into an overflow variable;
left shifting the overflow variable bitwise;
adding each element of the results vector with a corresponding bit of the overflow variable, storing each result into a corresponding element of the results vector and storing any resulting overflow bits into the overflow variable; and
if the overflow variable is nonzero, repeating said left shift and said adding of each element of the results vector with a corresponding bit of the overflow variable.

2. The method of claim 1, wherein the number of elements in the first number vector, the second number vector, and the results vector is 16.

3. The method of claim 1, wherein each element of the first number vector, the second number vector, and the results vector contains 32 bits.

4. The method of claim 1, wherein the method is incorporated into a multiplication process comprising:
organizing the binary representation of a third number as a vector having the same number of elements as the first number vector;
for each element of the third number vector, multiplying the element of the third number vector by a fourth number having the same number of bits as each element of the third number vector, wherein the multiplications are performed in parallel;
for each multiplication, saving a high order component of the product and a low order component of the product;
organizing the high order components for the multiplications into a higher-order vector, and organizing the low order components for the multiplications into a low order vector;
offseting the high and low order vectors by one element; and
adding the offset vectors according to the method of claim 1.

5. A system comprising:
a multi-core processor; and
a memory device in communication with said processor, wherein said memory device stores a plurality of processing instructions configured to direct said processor to cause the following:
organizing a binary representation of a first number as a first number vector having a number of elements;
organizing a binary representation of a second number as a number vector having the same number of elements as the first number vector;
adding each element of the first number vector with a corresponding element of the second number vector, where the additions are performed in parallel, and storing each sum into a respective element of a results vector having the same number of elements as the first number vector;
packing any resulting overflow bits, whether 0 or 1, into an overflow variable;
left shifting the overflow variable bitwise;
adding each element of the results vector with a corresponding bit of the overflow variable, storing each result into a corresponding element of the results vector and storing any resulting overflow bits into the overflow variable; and
if the overflow variable is nonzero, repeating said left shift and said adding of each element of the results vector with a corresponding bit of the overflow variable.

6. The system of claim 5, wherein the number of elements in the first number vector, the second number vector, and the results vector is 16.

7. The system of claim 5, wherein each element of the first number vector, the second number vector, and the results vector contains 32 bits.

8. The system of claim 5, wherein said plurality of processing instructions is further configured to direct said processor to cause the following:
organizing the binary representation of a third number as a vector having the same number of elements as the first number vector;
for each element of the third number vector, multiplying the element of the third number vector by a fourth number having the same number of bits as each element of the third number vector, wherein the multiplications are performed in parallel;
for each multiplication, saving a high order component of the product and a low order component of the product;
organizing the high order components for the multiplications into a higher-order vector, and organizing the low order components for the multiplications into a low order vector;
offseting the high and low order vectors by one element; and
adding the offset vectors according to the processing instructions of claim 5.

9. The system of claim 5, wherein said multi-core processor comprises a plurality of graphics processing unit (GPU) cores.

10. The system of claim 9, wherein said multi-core processor further comprises a plurality of central processing unit (CPU) cores.

11. A computer program product including non-transitory computer readable media having computer program logic stored therein, the computer program logic comprising:
logic to cause a multi-core processor to organize a binary representation of a first number as a number vector having a number of elements;
logic to cause the processor to organize a binary representation of a second number as a number vector having the same number of elements as the first number vector;
logic to cause the processor to add each element of the first number vector with a corresponding element of the second number vector, where the additions are performed in parallel, and storing each sum into a respective element of a results vector having the same number of elements as the first number vector;
logic to cause the processor to pack any resulting overflow bits, whether 0 or 1, into an overflow variable;
logic to cause the processor to left shift the integer variable bitwise;
logic to cause the processor to add each element of the results vector with a corresponding bit of the overflow variable, store each result into the corresponding element of the results vector, and store any resulting overflow bits into the overflow variable; and
logic to cause the processor to repeat said left shift and said adding of each element of the results vector with a corresponding bit of the overflow variable, if the overflow variable is nonzero.

12. The computer program product of claim 11, wherein the number of elements in the first number vector, the second number vector, and the results vector is 16.

13. The computer program product of claim 11, wherein each element of the first number vector, the second number vector, and the results vector contains 32 bits.

14. The computer program product of claim 11, wherein the computer program logic further comprises:
logic to cause the processor to organize the binary representation of a third number as a vector having the same number of elements as the first number vector;
logic to cause the processor to, for each element of the third number vector, multiply the element of the third number vector by a fourth number having the same number of bits as each element of the third number vector, the multiplications performed in parallel;
logic to cause the processor to, for each multiplication, save a high order component of the product and a low order component of the product;
logic to cause the processor to organize the high order components for the multiplications into a higher-order vector, and organize the low order components for the multiplications into a low order vector;
logic to cause the processor to offset the high and low order vectors by one element; and
logic to cause the processor to add the offset vectors using the computer program logic of claim 11.

15. The computer program product of claim 11, wherein the multi-core processor comprises a plurality of graphics processing unit (GPU) cores.

16. The computer program product of claim 15, wherein the multi-core processor further comprises a plurality of central processing unit (CPU) cores.

17. A system comprising:
a multi-core processor; and
a memory device in communication with said processor, wherein said memory device stores a plurality of processing instructions configured to direct said processor to cause the following,
organizing the binary representation of a first number as a first number vector having a number of elements;
organizing the binary representation of a second number as a second number vector having the same number of elements as the first number vector;
comparing the value of each element of the first number vector with a corresponding value of a corresponding element of the second number vector, where the comparisons are performed in parallel;
storing results of the comparisons into first and second comparison vectors each having the same number of elements as the first number vector, wherein for each comparison, if an element of the first number vector is greater than the corresponding element of the second number vector, the corresponding element of the first comparison vector is set to 1, and if the element of the first number vector is less than the corresponding element of the second number vector, the corresponding element of the second comparison vector is set to 1; and
determining which of the first and second numbers is greater by treating the first and second comparison vectors as respective first and second integers, and comparing the values of the first and second integers.

18. The system of claim 17, wherein the number of elements is 16 for each of the first number vector, the second number vector, the first comparison vector, and the second comparison vector.

19. The system of claim 17, wherein each element of the first number vector and second number vector is 32 bits.

20. The system of claim 17, wherein each comparison of an element of the first number vector and a corresponding element of the second number vector is executed by a respective core of said multi-core processor.

21. The system of claim 17, wherein said multi-core processor comprises a plurality of graphics processing unit cores.

22. The system of claim 21, wherein said multi-core processor further comprises a plurality of central processing unit cores.
